(19) United States
(12) Patent Application Publication
(10) Pub. No.: US 2011/0084657 A1
(43) Pub. Date: Apr. 14, 2011

(54) MOBILE DEVICE CHARGING BASE, AND MOBILE DEVICE AND CHARGING BASE SYSTEM

(76) Inventors: Shoichi TOYA, Minamiawaji-shi (JP); Hideyo Morita, Minamiawaji-shi (JP); Katsuaki Sasaji, Sumoto-shi (JP)

(21) Appl. No.: 12/903,560

(22) Filed: Oct. 13, 2010

(30) Foreign Application Priority Data
Oct. 14, 2009 (JP) 2009-237766

(51) Int. Cl. H02J 7/00

(52) U.S. Cl. 320/108

(57) ABSTRACT

A charging base for charging a mobile device includes an induction coil and a battery pack. The pack includes a battery charged by the induction coil. The base includes a base case, a mount portion, a power supply coil, and a power supply. The mount portion is recessed on the surface of the case, and can detachably hold the device. The power supply coil is arranged in proximity to and inside the recessed bottom surface of the mount portion to be electromagnetically coupled to the induction coil, and connected to the power supply coil. A cut-out portion is formed in a surface of the mount portion by partially cutting out the case to communicate with the outside. This surface intersects a mount surface of the device.

### BACKGROUND OF THE INVENTION

1. Field of the Invention

The present invention relates to a mobile device that includes a rechargeable battery, and a charging base that charges this mobile device.

2. Description of the Related Art

So-called non-contact charging bases have been developed that transmit electric power from a power supply coil to an induction coil through electromagnetic induction and charge a battery included in a mobile device (see Japanese Patent Laid-Open Publication No. H09-63655 and Japanese Utility Model Publication No. 3011829).

JP H09-63655-A discloses a system composed of a charging base including a power supply coil that can be energized by a high-frequency power supply, and a battery pack including an induction coil that is electromagnetically coupled to the power supply coil. The battery pack further includes a circuit that rectifies an altering current induced by the induction coil and provides the rectified current to its battery so that the battery is charged. According to this system, the battery of the battery pack can be charged in a non-contact manner with the battery pack being placed on the charging base.

Also, JP U 3011829 discloses a mobile device including a battery on the bottom side of the mobile device and a secondary charging adapter arranged under the battery. The secondary charging adapter includes an induction coil and a charging circuit.

JP U 3011829 also discloses a charging base including a power supply coil that can be electromagnetically coupled to the induction coil. The mobile device is placed on the charging base so that the secondary charging adapter is electromagnetically coupled to the power supply coil. The power supply coil transmits electric power to the induction coil, and charges the battery of the mobile device.

### SUMMARY OF THE INVENTION

It is important for such non-contact charging bases to place a mobile device at a predetermined position of the charging base. If the mobile device is not placed at a predetermined position, a battery of the mobile device may not be appropriately charged. For example, the system disclosed in Japanese Patent Laid-Open Publication No. H09-68655 has a disadvantage in that the battery pack cannot be charged if the battery pack is deviated from a predetermined position when placed on the charging base. The reason is that, if the battery pack is deviated from the predetermined position relative to the charging base, the induction coil cannot be not electromagnetically coupled to the power supply coil. Accordingly, deviation of the battery pack relative to the charging base prevents the power supply coil from transmitting electric power to the induction coil. This disadvantage can be solved by the charging base and the mobile device disclosed in Japanese Utility Model Publication No. 3011829. The charging base has a positioning protruding portion. The mobile device has a positioning recessed portion that can be fitted in the positioning protruding portion. According to this system composed of the mobile device and the charging base, the positioning protruding portion is guided into the positioning recessed portion so that deviation can be prevented between the mobile device and the charging base relative to each other.

However, the system disclosed in Japanese Utility Model Publication No. 3011829 has a disadvantage in that users feel it troublesome to guide the positioning protruding portion into the positioning recessed portion when placing the mobile device onto the charging base. Also, this system has another disadvantage in that users cannot always appropriately place the mobile device onto the charging base. In addition, since the positioning recessed portion is formed on the bottom surface of a case and the induction coil is arranged above the positioning recessed portion, this system has another disadvantage in that the mobile device cannot be configured thinner. A mobile device such as mobile phone is required to be configured as thin as possible. For this viewpoint, since the positioning recessed portion increase the thickness of a mobile device, the positioning recessed portion may cause inconvenience when users carry the mobile device.

These disadvantages can be solved by generating a magnetic field in a large area on the entire upper surface of the charging base to transmit electric power to the induction coil. However, in this case, since the magnetic field is generated even in a part of the upper surface of the charging base where the mobile device is not placed, there is a disadvantage in that the electric power efficiency is reduced that is transmitted from the power supply coil to the induction coil. In addition, there is another disadvantaged in that, if metal such as iron is placed on the charging base, heat may be generated by a current produced in the metal by magnetic induction.

The present applicant has developed a charging base that includes a power supply coil that is arranged under the upper plate of the charging base, and a movement mechanism that moves the power supply coil along the inside surface of the upper plate. This charging base detects the position of a mobile device placed on the upper plate, and moves the power supply coil to the induction coil of the mobile device by means of the movement mechanism. This charging base includes a position detection controller that detects the position of the mobile device placed on the upper plate of a case, and controls the movement mechanism so that the power supply coil is moved to the induction coil of the mobile device. This charging base transmits electric power from the power supply coil to the induction coil after the power supply coil is moved to the induction coil of the mobile device.

According to this charging base, a battery of the mobile device can be charged even irrespective of positional deviation of the mobile device. However, this charging base will be complicated. The reason is that this charging base requires a mechanism that moves the power supply coil to the induction coil of the mobile device, and a mechanism that detects the position of the mobile device. For this reason, this charging base has a disadvantage in that the manufacturing cost will be high.

In order to solve the aforementioned disadvantage, the present applicant has developed a charging base 10C shown in FIGS. 21 and 22. This charging base 10C has a mount portion 12C to which a mobile device 50 is mounted. The mount portion 12C has a curved bottom surface 13C that has a U-shaped groove. A power supply coil 21C is arranged inside the curved bottom surface 13C, and can be electromagnetically coupled to an induction coil 51C of the mobile device 50. Since the bottom surface of the mount portion is curved, in the case where the mobile device 50 has a curved back surface, when the mobile device 50 is put into the mount portion, the mobile device 50 will be guided by its own weight so that the curved back surface is positioned in the bottom of the curved bottom surface. According to this charging base, the induction coil included inside the curved bottom surface can be always brought in proximity to the power supply coil. Accordingly, electric power can be efficiently transmitted to the induction coil from the power supply coil. As a result, it is possible to quickly charge the battery.

However such a stand-type charging base that mounts a mobile device in a mount portion has a disadvantage in that the size and shape of the mobile device are restricted. For example, if the mobile device 50 has an entire length longer than that of FIG. 21, the induction coil 51C will be relatively deviated upward that is connected to the battery included in the mobile device 50. Accordingly, the induction coil 51C may not be appropriately electromagnetically coupled to the power supply coil 21C of the charging base. Also, some mobile devices may have various types of protrusions that protrude from the surfaces of the mobile devices. For example, in the case where a mobile device has an exterior shape in that a strap or electric terminals protrude from the lower surface or the back surface of the mobile device, such protrusions interfere with the mount portion of the charging base. In this case, the back surface of the mobile device cannot be properly placed on the mount portion of the charging base. As a result, the induction coil may be prevented from being electromagnetically coupled to the power supply coil. In this case, since the charging base can appropriately charge only a mobile device that has a predetermined shape and predetermined size, the usability of the charging base will be poor. For this reason, there is a disadvantage in that a dedicated charging base is required by each mobile device.

In addition, from viewpoint of electromagnetic coupling, it is important to bring the mount portion in contact with the mobile device. However, in the case where the mount portion is brought in contact with the mobile device, there is a disadvantage in that heat is locally generated by charging operation.

The present invention is aimed at further solving the disadvantages. It is an main object of the present invention to provide a mobile device charging base, and a mobile device and charging base system capable of properly charging batteries of mobile devices with different sizes.

A mobile device charging base according to a first aspect of the present invention is a charging base 10 capable of charging a mobile device 50 including an induction coil 51 and a battery pack 70. The battery pack 70 includes a battery 54 to be charged by electric power induced in this induction coil 51. The charging base 10 can include a base case 11, a mount portion 12, a power supply coil 21, and a power supply 22. The mount portion 12 is formed in a recessed shape in section on the surface of the base case 11, and can detachably hold the mobile device 50 at a predetermined position. The power supply coil 21 is arranged in proximity to and inside the recessed bottom surface of the mount portion 12, and can be electromagnetically coupled to the induction coil 51 for the battery pack 70 that is attached to the mobile device 50. The power supply 22 is connected to the power supply coil 21. In addition, a cut-out portion 85 can be formed in a surface of the mount portion 12 by cutting out a part of the base case 11. This surface of the mount portion 12 intersects a mount surface of the mobile device 50 that extends along the recessed bottom surface. The cut-off portion 85 communicates with the outside. According to this charging base, even if a mobile device has a protruding member that protrudes from the lower surface of the mobile device, a protruding portion can be brought in the cut-out portion. Thus, the mobile device can be properly placed so that the back surface of the mobile device is arranged in contact with the mount portion. Therefore, it is possible to appropriately charge a battery of the mobile device. Also, since the cut-out portion communicates with the mount portion that receives the mobile device, the wall of the mount portion that surrounds the mobile device does not exist in this communicating part. Thus, the surface of the mobile device can be exposed. Accordingly, this communicating part can dissipate heat. Therefore, it is possible to suppress that heat is stored in the mobile device in charging/discharging operation. As discussed above, although the mount portion required for electromagnetic induction can be arranged in contact with the mobile device, a part of the surface of the mount portion is cut out that is not required for electromagnetic induction. As a result, it is possible to ensure heat dissipation in addition to appropriate electromagnetic induction.

In a mobile device charging base according to a second aspect of the present invention, a second cut-out portion 86 can be additionally formed in the recessed bottom surface of the mount portion 12. The second cut-out portion 86 communicates with the cut-out portion 85, and extends in a part of the recessed bottom surface from the edge of the surface intersecting the mount surface so that the edge of the base case 11 opens in a substantially rectangular U shape. According to this charging base, since the cut-out portions are continuously formed from the bottom surface, which supports the mobile device, to the back surface, the edge of the base case can be cut out in a rectangular U shape. Therefore, this charging base can hold even a mobile device having a protruding portion that protrudes from the bottom surface to the back surface of the mobile device. In addition, it is possible to increase the area of a part of a mobile device that is exposed from the base case, and to improve heat dissipation effect.

A mobile device charging base according to a third aspect of the present invention can include a spacer 90 that can be attached to a stopper wall 14 so that an actual size of the mount portion 12 can be changed. The stopper wall 14 can support the lower surface of the mobile device 50. According to this charging base, the bottom of the mount portion can be shifted upward/downward by attachment/detachment of the space to the mount portion. Since an actual size of the spacer can be changed, the mount portion appropriately can receive even a mobile device with a size smaller than the originally-designed size of the mount portion. Therefore, it is possible to appropriately charge a battery of a smaller mobile device.

In a mobile device charging base according to a fourth aspect of the present invention, the spacer 90 can include two block portions 91, and a coupling portion 92. The two block portions 91 are coupled to each other by the coupling portion 92. In addition, the block portions 91 can be designed to have surfaces 97 substantially coplanar with interior wall surfaces 89 of the base case 11 when the spacer 90 is attached to the mount portion 12. The interior wall surfaces 89 of the base case 11 face each other, and define the cut-out portion 85. According to this charging base, even in the case where the spacer is attached to the mount portion, the mount portion can communicate with the cut-out portion via the spacer. Therefore, the advantages of the cut-out portion are not reduced.

In a mobile device charging base according to a fifth aspect of the present invention, the spacer 90 can have a positioning protruding section 93 that protrudes toward a side to be inserted into the mount portion 12. In addition, a positioning recessed section 87 can be formed at a position of the mount portion 12 corresponding to the positioning protruding section 93 so that, when the positioning protruding section 93 of the spacer 90 is inserted into the positioning recessed section 87 of the mount portion 12, the spacer 90 is positioned in place. According to this charging base, the spacer can be easily attached in place at a predetermined orientation.

In a mobile device charging base according to a sixth aspect of the present invention, the base case 6 can have a spacer accommodation portion 96 that accommodates the spacer 90. According to this charging base, since the spacer can be accommodated in the base case when the spacer is not in use, it is possible to reduce the possibility of losing the spacer not in use.

In a mobile device charging base according to a seventh aspect of the present invention, the mount portion 12 can be formed inclined on the base case 11. According to this charging base, since users can place the mobile device onto the mount portion from the top side and the transverse sides, it is possible to improve the usability of the charging base.

In a mobile device charging base according to an eighth aspect of the present invention, the spacer accommodation portion 96 can be located on the underside of the base case 11 that is a side opposite to the side where the mount portion 12 is formed. According to this charging base, since the spacer accommodation portion is not externally exposed when the charging base is in use, it is possible to provide a cleanly styled charging base with smooth lines, and additionally to effectively use dead space in the case where the mount portion 12 is formed inclined.

In a mobile device charging base according to a ninth aspect of the present invention, the mount portion 12 can have a substantially U shape in section. According to this charging base, since a mobile device can be placed onto the mount portion even when the mobile device is inclined to some extent, users can easily place the mobile device onto the charging base. In addition, since a mobile device can be moved with wobbling or sliding on the mount portion by its own weight, the mobile device is likely to be placed at a proper orientation.

A mobile device and charging base system according to a tenth aspect of the present invention includes a mobile device 50, and a charging base 10. The mobile device 50 has a device case, a rechargeable battery, and an induction coil 51. The rechargeable battery is detachably attached to the device case. The induction coil 51 charges the rechargeable battery by induced electric power. The charging base 10 has a base case 11, a mount portion 12, a power supply coil 21, and a power supply 22. The mount portion 12 is formed in a recessed shape in section on the surface of the base case 11, and can detachably hold the mobile device 50 at a predetermined position. The power supply coil 21 is arranged in proximity to and inside a recessed bottom surface of the mount portion 12, and can be electromagnetically coupled to the induction coil 51 of the mobile device pack 50 that is placed on the mount portion 12. The power supply 22 is connected to the power supply coil 21. The charging base 10 has a cut-out portion 85 that is formed in a surface of the mount portion 12 by cutting out a part of the base case 11. This surface of the mount portion extends along the recessed bottom surface of the mount portion 12, and intersects a mount surface of the mobile device 50. The cut-off portion 85 communicates with the outside. According to this mobile device and charging base system, even if a mobile device has a protruding member that protrudes from the lower surface of the mobile device, a protruding portion can be brought in the cut-out portion. Thus, the mobile device can be properly placed so that the back surface of the mobile device is arranged in contact with the mount portion. Therefore, it is possible to appropriately charge a battery of the mobile device. Also, since the cut-out portion communicates with the mount portion that receives the mobile device, the wall of the mount portion that surrounds the mobile device does not exist in this communicating part. Thus, the surface of the mobile device can be exposed. Accordingly, this communicating part can dissipate heat. Therefore, it is possible to suppress that heat is stored in the mobile device in charging/discharging operation. As discussed above, although the mount portion required for electromagnetic induction can be arranged in contact with the mobile device, a part of the surface of the mount portion is cut out that is not required for electromagnetic induction. As a result, it is possible to ensure heat dissipation in addition to appropriate electromagnetic induction.

In a mobile device and charging base system according to an eleventh aspect of the present invention, an option unit OU can be coupled to the device case of the mobile device 50. In addition, the mount portion 12 of the charging base 10 can be designed so that the power supply coil 21 is electromagnetically coupled to the induction coil 51 when the mobile device 50 with the option unit OU coupled thereto is placed on the mount portion 12. The mount portion 12 of the charging base 10 can receive a spacer 90 that adjusts the position of the mobile device 50 so that the power supply coil 21 is electromagnetically coupled to the induction coil 51 even when the mobile device 50 without the option unit OU is placed on the mount portion 50. According to this mobile device and charging base system, even in the entire length of a mobile device is changed by attachment/detachment of the option unit, since the size of the mount portion can be changed by shifting the bottom of the mount portion upward/downward by attachment/detachment of the spacer, it is possible to appropriately charge a battery of the smaller mobile device with or without the option unit.

The above and further objects of the present invention as well as the features thereof will become more apparent from the following detailed description to be made in conjunction with the accompanying drawings.

### BRIEF DESCRIPTION OF THE DRAWINGS

FIG. 1 is a perspective view showing a mobile device charging base according to an embodiment of the present invention;

FIG. 2 is a perspective view showing the charging base shown in FIG. 1 with a spacer being attached to a left mount portion of the charging base;

FIG. 3 is a perspective view showing the charging base shown in FIG. 1 as viewed from the bottom side;

FIG. 4 is a perspective view showing the charging base shown in FIG. 3 with the spacer being mounted to a upper-side (as viewed in the Figures) spacer accommodation portion of the charging base;

FIG. 5 is a perspective view showing the charging base and electric devices placed on the charging base with the spacers shown in FIG. 2 being attached to the mount portions;

FIG. 6 is a perspective view showing the charging base and the electric devices shown in FIG. 5 with the electric devices being covered by covering members;

FIG. 7 is a perspective view showing the charging base and the electric devices shown in FIG. 5 with option units being attached to the electric devices;

FIG. 8 is a perspective view showing the charging base and the electric devices with option units shown in FIG. 7 with the electric devices being covered by covering members;

FIG. 9 is an exploded perspective view showing the charging base shown in FIG. 1 with an upper base case being removed from a lower base case;

FIG. 10 is a cross-sectional view of the charging base and the electric device taken along a line X-X shown in FIG. 5;

FIG. 11 is a cross-sectional view of the charging base and the electric device taken along a line XI-XI shown in FIG. 6;

FIG. 12(a) is a perspective view showing a mobile device having neither the option unit nor the covering member;

FIG. 12(b) is a perspective view showing the mobile device having the option unit without the covering member;

FIG. 13(a) is a perspective view showing a mobile device having the covering member without the option unit;

FIG. 13(b) is a perspective view showing the mobile device having the option unit and the covering member;

FIG. 14 is a perspective view of the spacer as viewed from the top side;

FIG. 15 is a perspective view of the spacer as viewed from the back side;

FIG. 16 is a vertically cross-sectional view showing a charging base with a light guiding member according to a modified embodiment, and the mobile device;

FIG. 17 is a block circuit diagram of the mobile devices and the charging base;

FIG. 18 is a perspective view showing the mobile device with a battery pack being removed from the mobile device;

FIG. 19 is a perspective view showing the battery pack shown in FIG. 18 as viewed from the bottom side;

FIG. 20 is an exploded perspective view showing the battery pack shown in FIG. 19;

FIG. 21 is a perspective view showing a charging base and a mobile device that have been developed by the present applicant; and

FIG. 22 is a cross-sectional view of the charging base and the electric device taken along a line XXII-XXII shown in FIG. 21.

### DETAILED DESCRIPTION OF THE EMBODIMENT(S)

The following description will describe embodiments according to the present invention with reference to the drawings. It should be appreciated, however, that the embodiments described below are illustrations of a mobile device charging base and a mobile device and charging base system to give a concrete form to technical ideas of the invention, and a mobile device charging base and a mobile device and charging base system of the invention are not specifically limited to description below. Furthermore, it should be appreciated that the members shown in claims attached hereto are not specifically limited to members in the embodiments. Unless otherwise specified, any dimensions, materials, shapes and relative arrangements of the members described in the embodiments are given as an example and not as a limitation. Additionally, the sizes and the positional relationships of the members in each of drawings are occasionally shown larger exaggeratingly for ease of explanation. Members same as or similar to those of this invention are attached with the same designation and the same reference numerals, and their description is omitted. In addition, a plurality of structural elements of the present invention may be configured as a single part that serves the purpose of a plurality of elements, on the other hand, a single structural element may be configured as a plurality of parts that serve the purpose of a single element. Also, the description of some of examples or embodiments may be applied to other examples, embodiments or the like.

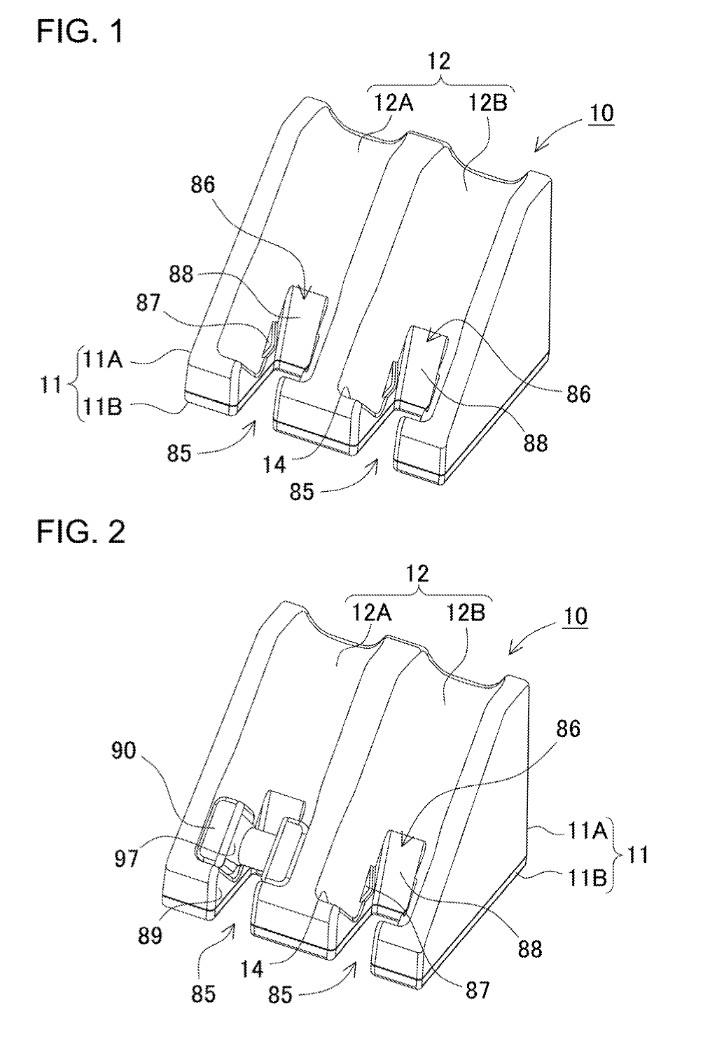

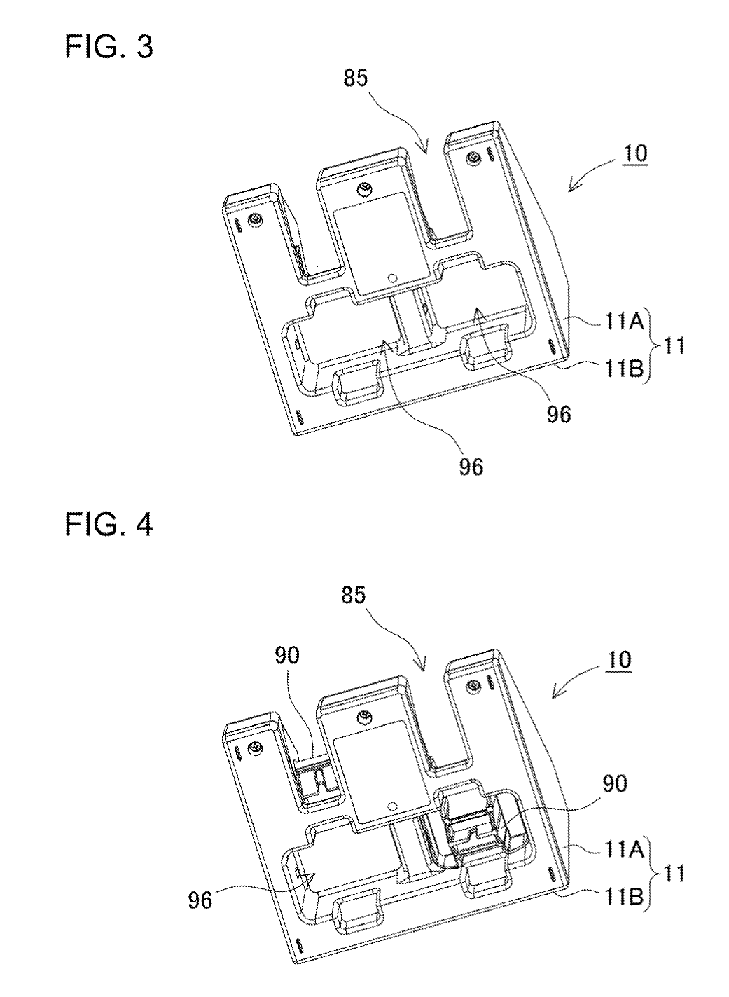

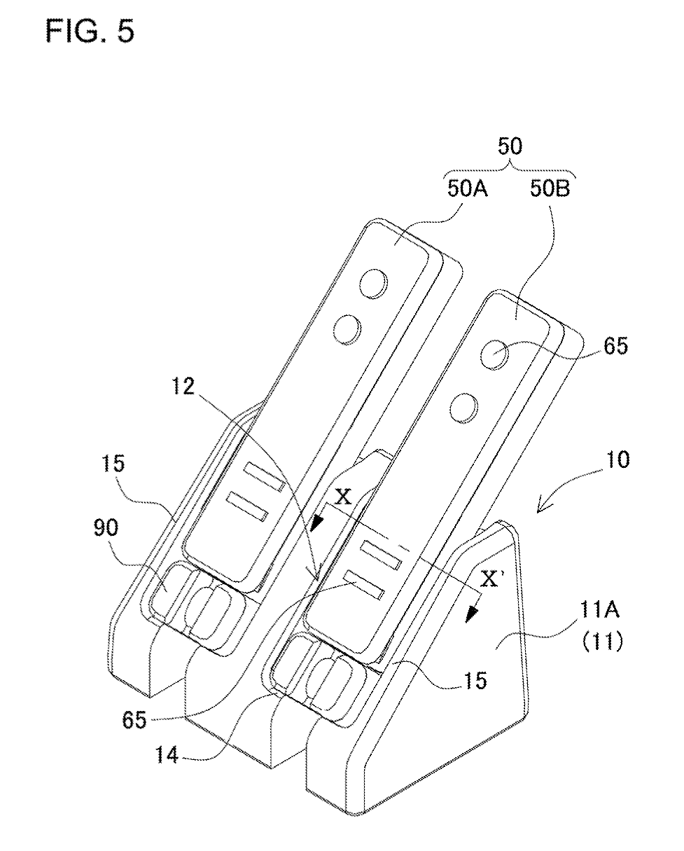

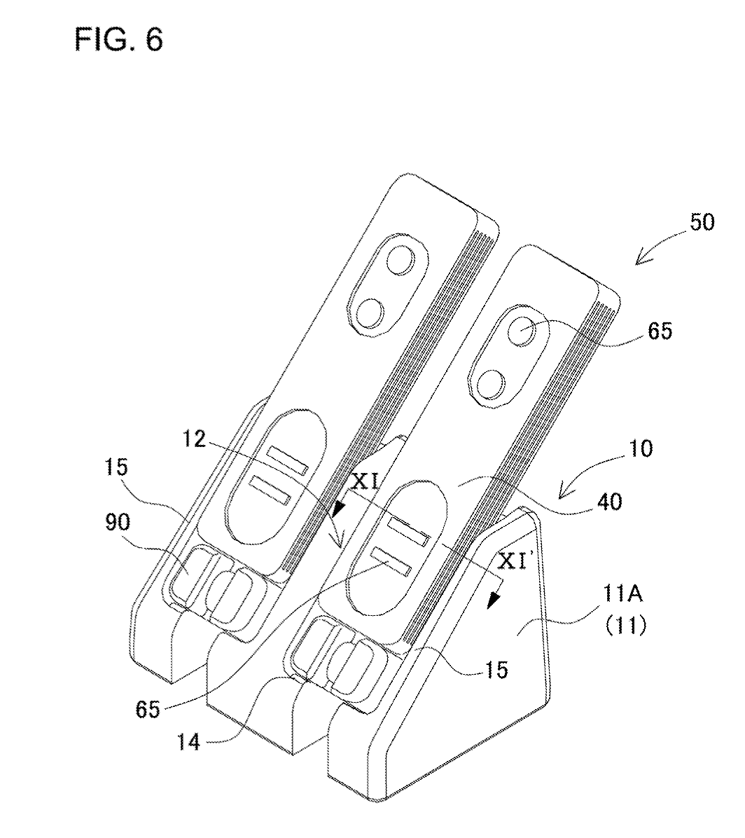

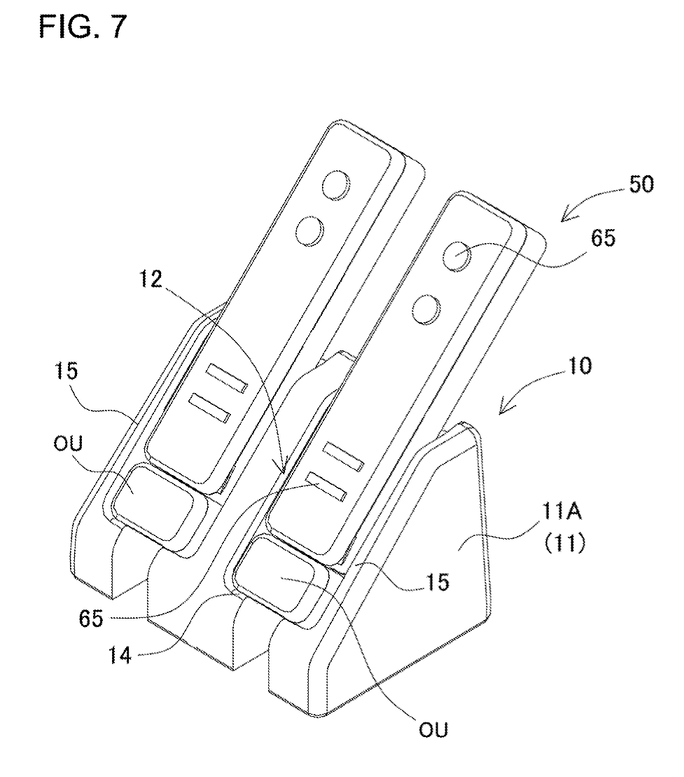

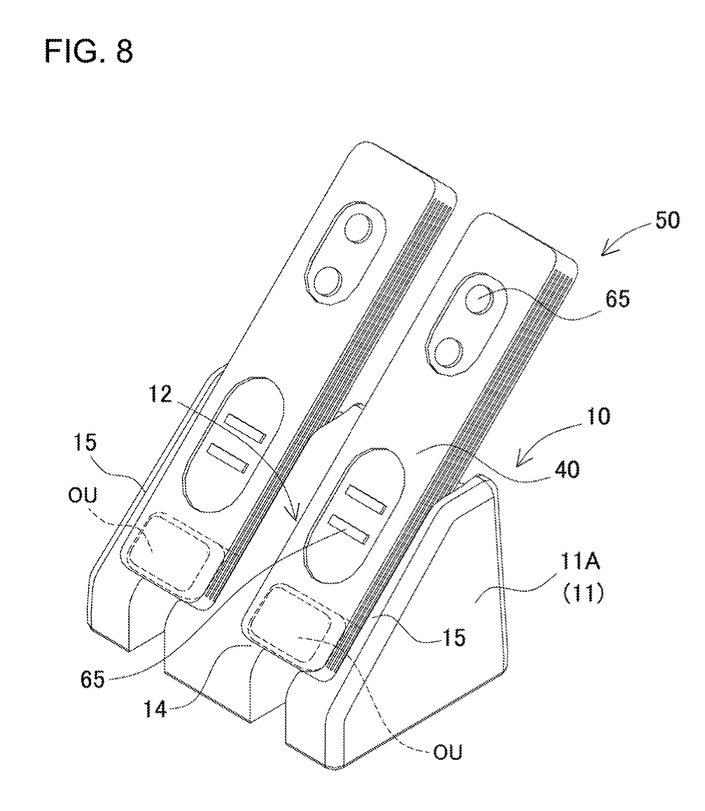

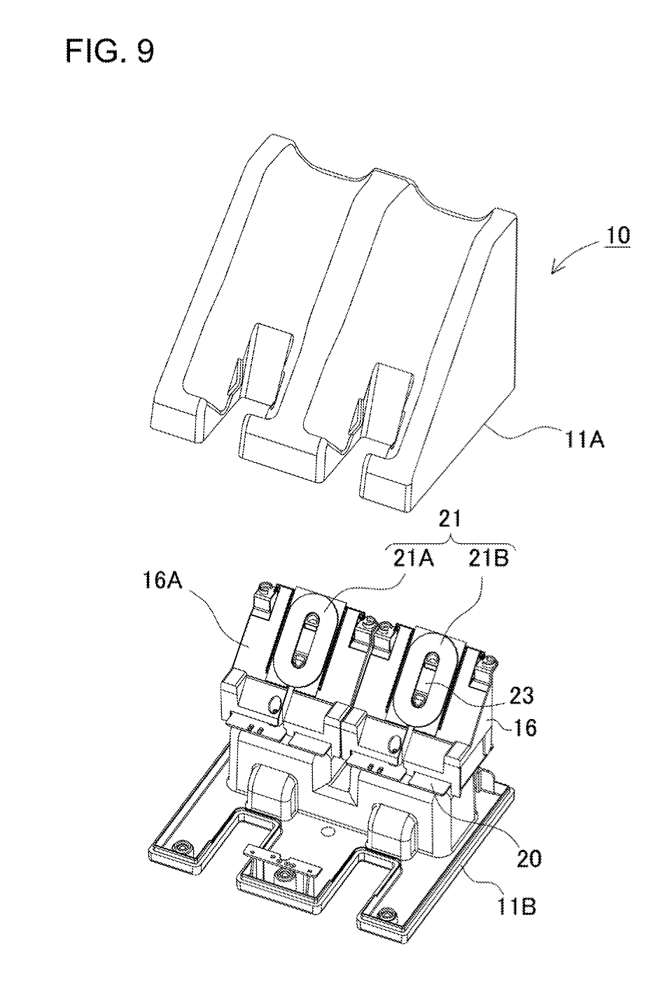

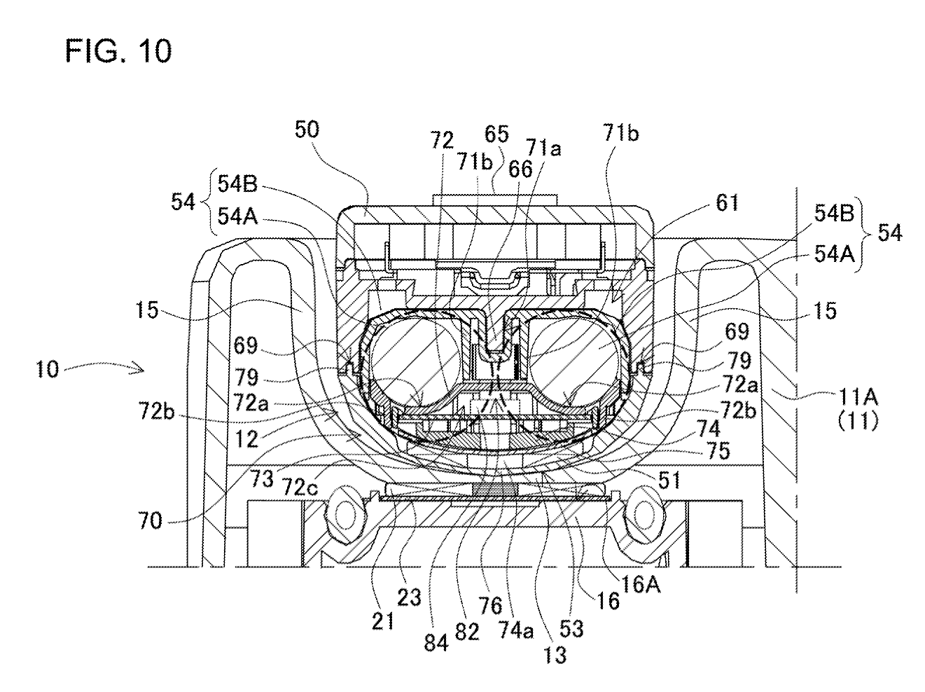

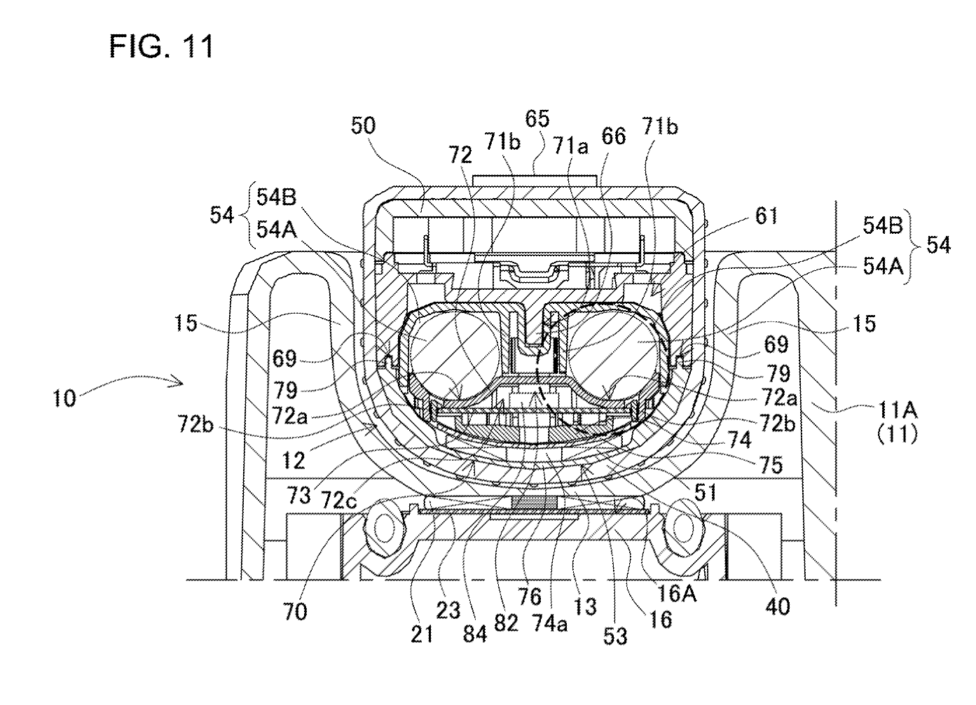

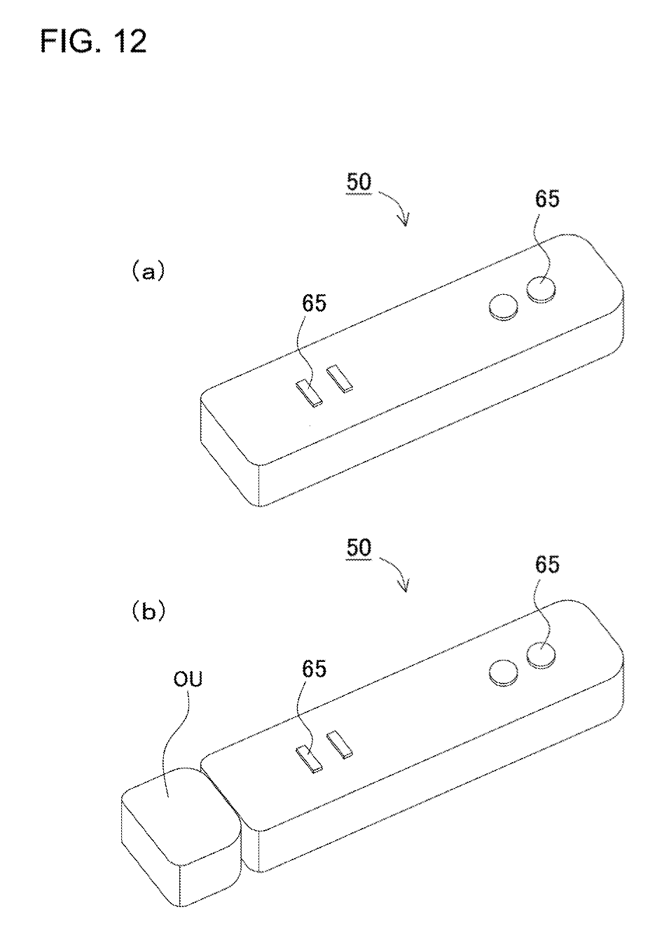

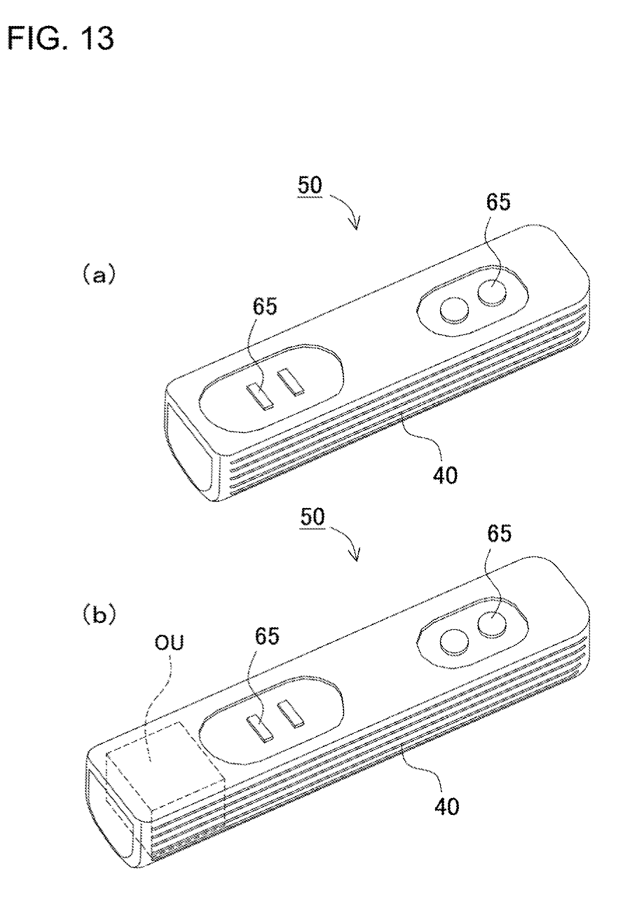

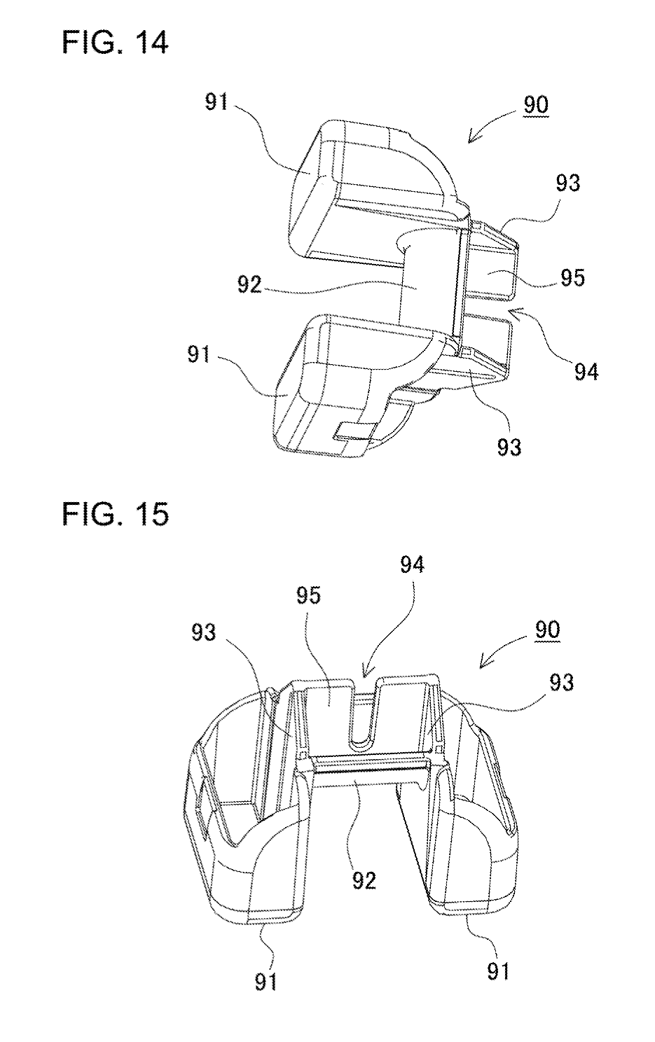

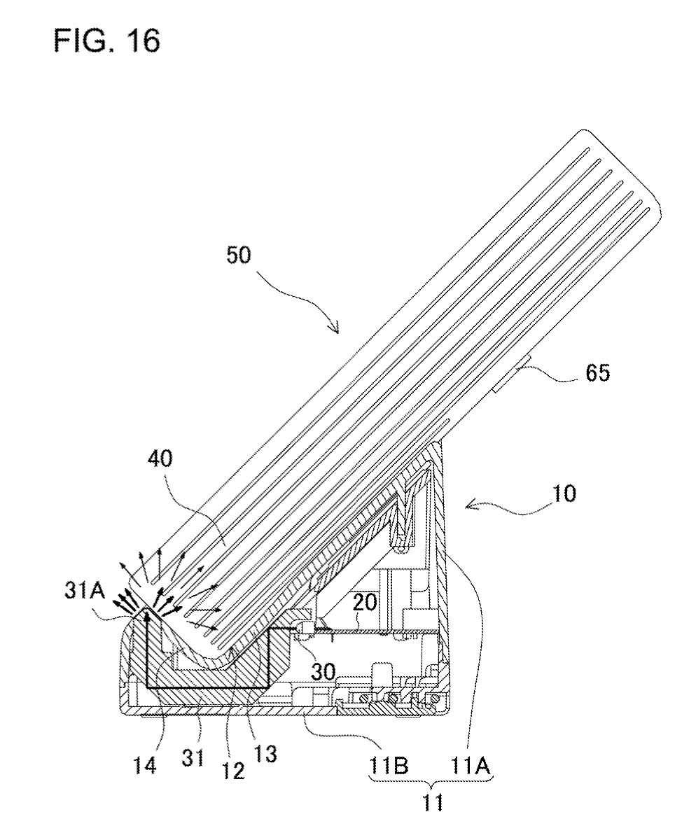

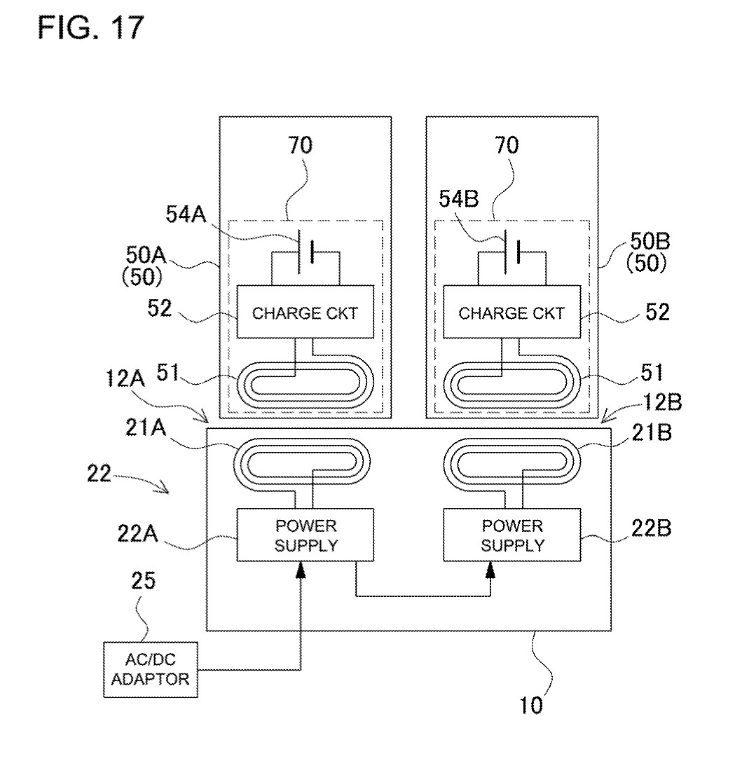

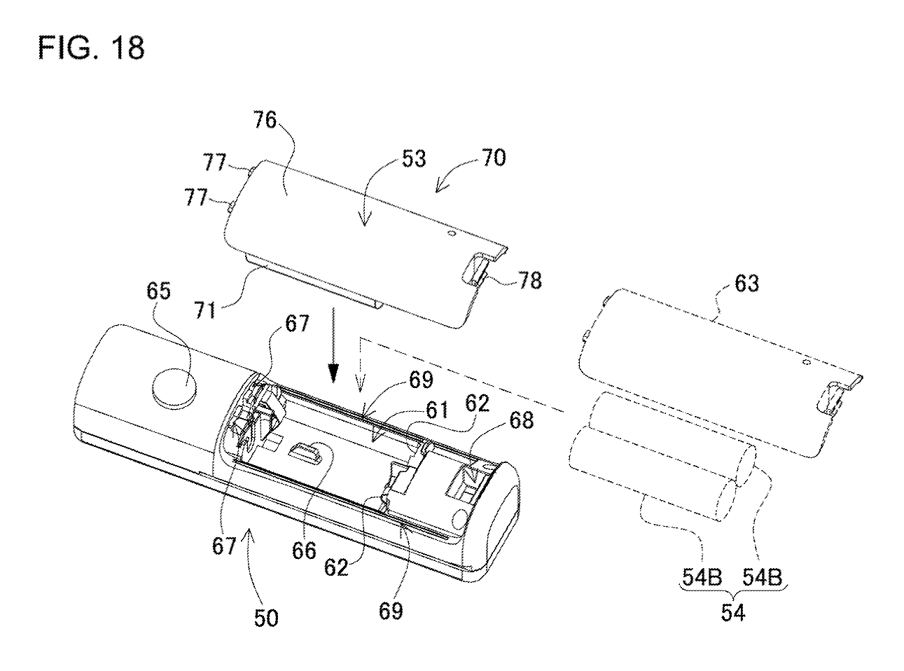

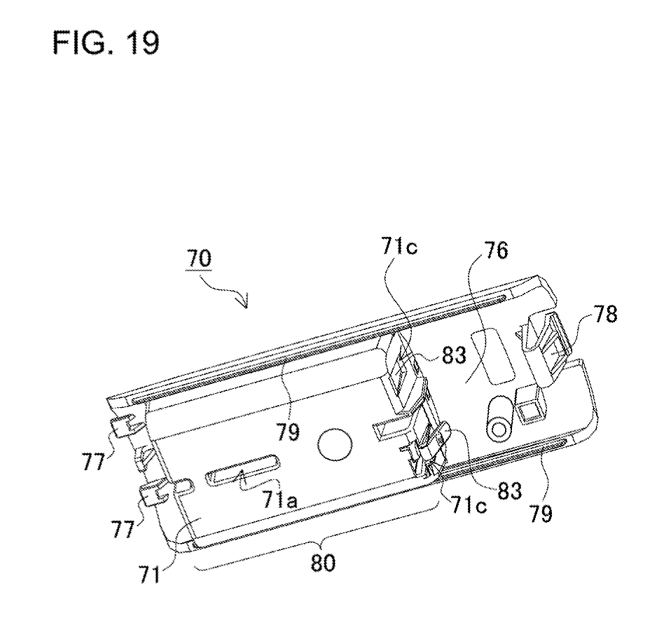

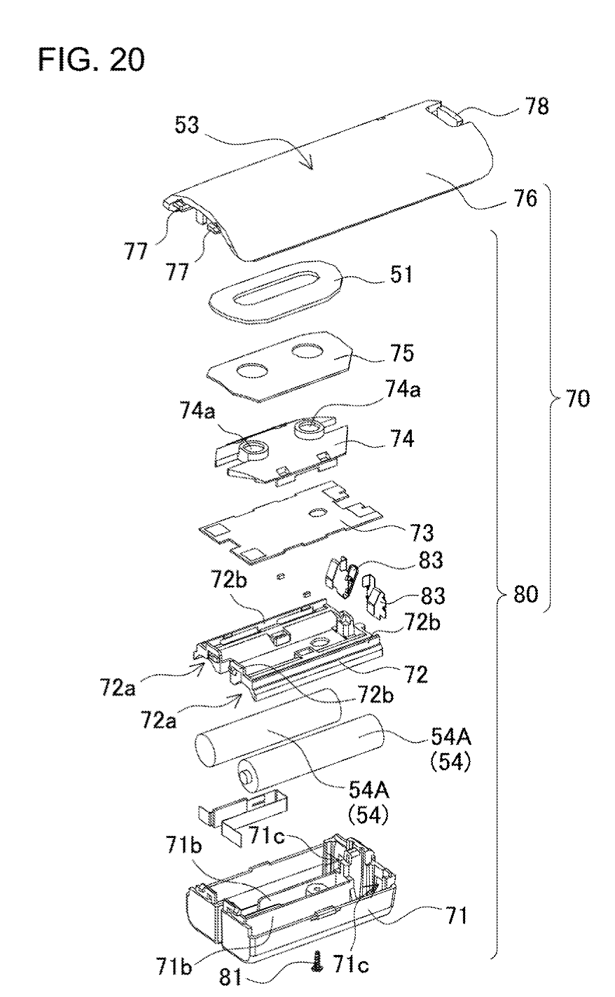

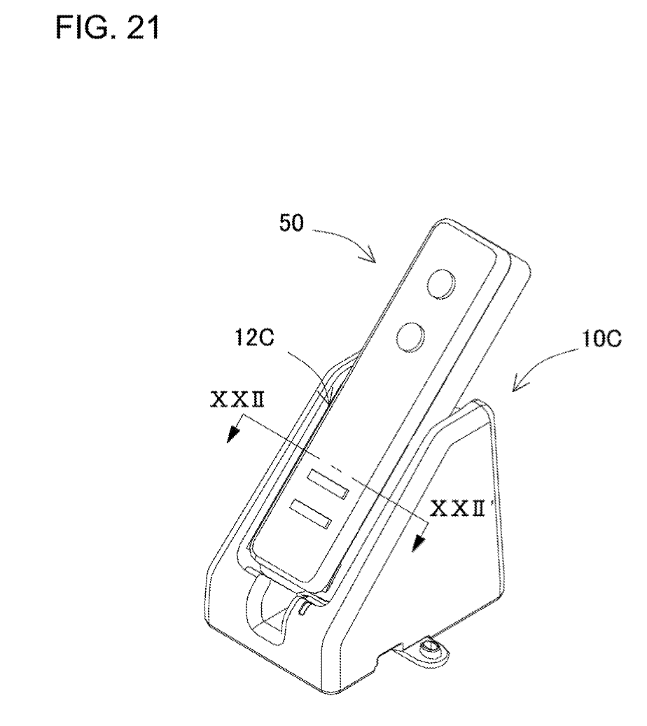

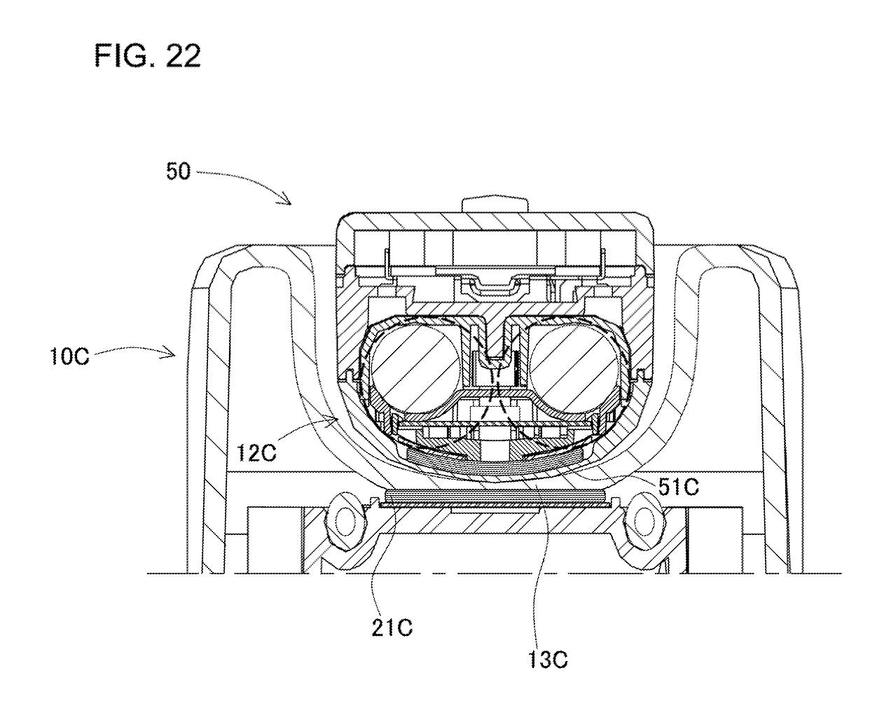

FIGS. 1 to 20 show a charging base and mobile devices according to an embodiment of the present invention. FIG. 1 is a perspective view of the charging base for the mobile devices. FIG. 2 is a perspective view showing a perspective view showing the charging base shown in FIG. 1 with a spacer being mounted to a left mount portion of the charging base. FIG. 3 is a perspective view showing the charging base shown in FIG. 1 as viewed from the bottom side. FIG. 4 is a perspective view showing the charging base shown in FIG. 3 with the spacer being mounted to an upper-side (as viewed in the Figures) spacer accommodation portion of the charging base. FIG. 5 is a perspective view showing the charging base and electric devices placed on the charging base with the spacers shown in FIG. 2 being attached to the mount portions. In FIG. 5, an option unit is not attached to the mobile device, and a covering member does not cover the mobile device. FIG. 6 is a perspective view showing the charging base and the electric devices shown in FIG. 5 with the electric devices being covered by covering members and placed on the charging base. FIG. 7 is a perspective view showing the charging base and the electric devices shown in FIG. 5 with option units being attached to the electric devices without using a spacer. FIG. 8 is a perspective view showing the charging base and the mobile devices with option units shown in FIG. 7 with the mobile devices being covered by covering members and placed on the charging base. FIG. 9 is an exploded perspective view showing the charging base shown in FIG. 1 with an upper base case being removed from a lower base case. FIG. 10 is a cross-sectional view of the charging base and the electric device taken along a line X-X shown in FIG. 5. FIG. 11 is a cross-sectional view of the charging base and the electric device taken along a line XI-XI shown in FIG. 6. FIG. 12(a) is a perspective view showing a mobile device having neither the option unit nor the covering member. FIG. 12(b) is a perspective view showing a mobile device having the option unit without the covering member. FIG. 13(a) is a perspective view showing a mobile device having the covering member without the option unit. FIG. 13(b) is a perspective view showing a mobile device having the option unit and the covering member. FIG. 14 is a perspective view of the spacer as viewed from the top side. FIG. 15 is a perspective view of the spacer as viewed from the back side. FIG. 16 is a vertically cross-sectional view showing a charging base with a light guiding member according to a modified embodiment, and the mobile device. FIG. 17 is a block circuit diagram of the mobile devices and the charging base. FIG. 18 is a perspective view showing the mobile device with battery packs being removed from the mobile device. FIG. 19 is a perspective view showing the battery pack shown in FIG. 18 as viewed from the bottom side. FIG. 20 is an exploded perspective view showing the battery pack shown in FIG. 19.

The illustrated charging base 10 includes a power supply coil 21, a power supply 22, and a base case 11 that accommodates the power supply coil 21 and the power supply 22. The base case 11 is composed of two parts of upper and lower base cases 11A and 11B as shown in FIG. 9, etc. The outward appearance of the base case 11 is a substantially triangular prism shape as shown in FIGS. 1 to 8. Mount portions 12 are formed on an inclined surface of the triangular prism shape. The illustrated exemplary charging base 10 has two mount portions 12A and 12B. Two mobile devices 50A and 50B can be placed on the two mount portions 12A and 12B, and can be charged one by one or simultaneously. The mount portions 12 are formed in a recessed shape in section. The mobile devices 50 are detachably mounted to the mount portions 12, and can be charged. The charging operation is conducted in a non-contact manner by using electromagnetic coupling between an induction coil 51 and the power supply coil 21 so that terminals are not exposed. The power supply coil 21 is arranged inside the base case 11 (on the interior side of the recessed bottom surface of the mount portion 12). The mobile device 50 includes the induction coil 51 to be electromagnetically coupled to the power supply coil 21.

The mobile device 50 includes a device case, a battery pack, and the induction coil 51. The battery pack is detachably attached to the device case, and includes rechargeable batteries. The induction coil 51 that charges the rechargeable batteries by induced electric power. The material and the shape of the device case can be suitably designed depending on the applications and the like of mobile devices. For example, the device case can be formed of polycarbonate, or the like. An option unit OU can be coupled to the device case. When the mobile device 50 is detachably placed onto the mount portion 12 of the base case 11, the charging base 10 can charge the batteries 54 of the mobile device 50.

### (Mobile Device 50)

The mobile device 50 includes the induction coil 51, and the battery 54 to be charged by electric power transmitted to the induction coil 51, as shown in FIGS. 10, 11 and the like. Various types of devices can be used as the mobile device 50. Examples of the mobile device 50 can be provided by remote control unit for operating electronic devices such as video game electronic devices, cordless handset, mobile phone, mobile terminal, PDA, smart phone, pager, portable music player, and the like. The option unit OU is refers to as an external device that can be coupled to the mobile device 50, and changes the entire length of the mobile device when being coupled to the mobile device 50. Examples of the option unit OU can be provided by a sensor for improving the position detecting accuracy of a game controller, an additional battery for increasing battery run time of a mobile phone, etc, a TV tuner, an electronic money communication unit, and the like. FIG. 12 shows an exemplary outward appearance of the mobile device. FIG. 12(a) shows the mobile device without an option unit. FIG. 12(b) shows the mobile device with an option unit.

In addition, a covering member 40 can be attached to the exterior of the mobile device 50. The covering member 40 can protect the mobile device 50 from shock in accidental drop, collision and the like, and can provide non-slip effect when users grasp the mobile device 50. FIG. 13 shows the mobile device 50 with the covering member 40 being coupled to the mobile device 50. FIG. 13(a) shows the mobile device having the covering member without the option unit. FIG. 13(b) shows the mobile device having the option unit and the covering member.

### (Mount Portion 12)

The mount portion 12 to which the mobile device 50 is mounted preferably has a substantially U shape in section. In this case, since the mobile device 50 can be placed onto the mount portion 12 even when the mobile device 50 is inclined to some extent, users can easily place the mobile device 50 onto the charging base 10. In addition, since the mobile device 50 can be moved with wobbling or sliding on the mount portion 12 by its own weight, the mobile device 50 is likely to be placed at a proper orientation. In the case where the base cases 11 have a right-triangular shape, the mount portion 12 is preferably formed on an inclined side of the right-triangular shape. In this case, since the mount portion 12 is inclined, when users can place the mobile device 50 onto the charging base 10, the users can place the mobile device 50 onto the charging base 10 from the top side and the transverse sides. Therefore, the charging base 10 has excellent usability.

The mount portion 12 has a bottom surface that serves as a stopper wall 14. The stopper wall 14 supports the mobile device 50. The top side of the mount portion opens. Accordingly, the mobile device can be held protruding upward from the charging base. In this case, since the upward protruding amount can be adjusted, even a long mobile device can be placed on the mount portion. In order to charge even a long mobile device when the long mobile device can be placed on the mount portion, more specifically, in order that the induction coil 51 of the mobile device can be positioned at the power supply coil 21 included in the charging base 10, the mount portion 12 can adjust the height of the mobile device by using a spacer 90. Specifically, as shown in FIG. 2, the spacer 90 is prepared that has a predetermined height so that, when the spacer 90 is attached to the bottom surface of the mount portion 12, the actual height of the bottom surface of the mount portion 12 is raised so that the induction coil 51 of each of mobile devices with different lengths is brought to the same position as the power supply coil 21. In the case where a spacer is prepared that has an adjusted height depending on the length of a mobile device, one charging base can suitably receive mobile devices with different lengths.

The spacer is used to raise a short mobile device. For this reason, it is preferable that the mount portion suitably receives the longest mobile device when the spacer is not used. In the case of a shorter mobile device, the spacer is used to raise the actual height of the bottom surface of the mount portion so that the shorter mobile device is positioned at the predetermined position.

The spacer can provide one charging base with compatibility between mobile devices with different lengths, and can improve the usability of the charging base. The mobile devices with different lengths include not only mobile devices with different physical, dimensional overall lengths, but also mobile devices with different lengths resulting from an option unit coupled to a mobile device. In the case where the spacer is provided, the shape and dimension of the mount portion 12, the positional arrangement of the power supply coil 21 inside the mount portion 12, and the like are designed so that, when a mobile device elongated by the option unit OU coupled to the mobile device is placed on the mount portion 12, the induction coil 51 of the elongated mobile device is electromagnetically coupled to the power supply coil 21 inside the mount portion 12. In this case, when a shorter mobile device without the option unit OU is placed on the mount portion 12, the spacer is used to raise the actual height of the bottom surface of the mount portion 12 so that the induction coil 51 of the shorter mobile device is electromagnetically coupled to the power supply coil 21 inside the mount portion 12. In other words, in the case where the spacer is dimensioned so that its height is same as the option unit, the spacer can match the height of a mobile device without the option unit with the height of a mobile device with the option unit. Accordingly, one charging base can charge a mobile device irrespective of whether the option unit is coupled to the mobile device or not.

### (Spacer 90)

FIGS. 14 and 15 show an exemplary outward appearance of the spacer 90. The illustrated spacer 90 has substantially rectangular-shaped block portions 91, and a coupling portion 92. The substantially rectangular-shaped block portions 91 are coupled by the coupling portion 92. Thus, the entire shape of the spacer 90 is a substantially U shape. The block portions 91 and the coupling portion 92 are integrally formed of resin such as plastic. As shown in FIG. 2, the block portions 91 are preferably designed to have surfaces 97 coplanar with interior wall surfaces 89 of a later-discussed cut-out portion 85 when the spacer 90 is attached to the mount portion 12. The interior wall surfaces 89 of the base case 11 face each other. Accordingly, the spacer 90 does not affect the action of the cut-out portion 85 even when the spacer 90 is attached to the mount portion. Therefore, the charging base can provide the effect by the cut-out portion 85. That is, even in the case where the spacer 90 is attached to the mount portion, the mount portion can communicate with the cut-out portion 85 via the spacer 90. Thus, the cut-out portion 85 can accommodate a protrusion that protrudes from the bottom or back surface of the mobile device 50. Accordingly, such a protrusion does not interfere with the mount portion 12 when the mobile device 50 is mounted to the mount portion 12. Therefore, the mobile device 12 can be appropriately electromagnetically coupled to the charging base.

### (Positioning Protruding Section 93)

Positioning protruding sections 93 are formed on the coupling portion 92 of the spacer 90. The positioning protruding sections 93 are formed in a shape that can be inserted into positioning recessed sections 87 formed on a later-discussed second cut-out portion 86. Thus, the spacer 90 can be positioned and mounted into a predetermined position of the mount portion 12 by the positioning protruding sections 93 and the positioning recessed sections. The exemplary positioning protruding sections 93 shown in FIGS. 14 and 15 have a triangular shape as an extension part of each of the surfaces 97 of the block portions 91 that face each other. The triangular positioning protruding sections 93 are suitable for adjusting the spacer 90 to a predetermined orientation when the spacer 90 is inserted into positioning recessed sections even if an insertion direction of the spacer 90 is slightly deviated from the predetermined insertion direction.

### (Slit 94)

The coupling portion 92 coupled between the positioning protruding sections 93 includes a plate-shaped connecting section 95 that is formed in a wall shape protruding in a direction so that the plate-shaped connecting section 95 closes the second cut-out portion 86. A U-shaped slit 94 may be formed in the connecting section 95. In the case where the slit 94 is formed, the coupling portion 92 does not completely close the second cut-out portion 86. Accordingly, the slit 94 allows narrow members such as cable or cord can pass to pass through the second cut-out portion 86. In particular, in the case where a strap hangs from the back surface of a mobile device, the slit 94 allows the strap to pass through the second cut-out portion. Therefore, it is possible to prevent the strap is caught when in free.

The spacer 90 has a symmetrical shape both in left-and-right and front-and-back directions. Thus, the spacer 90 can be attached to the mount portion 12 in any orientations. Accordingly, the attachment direction of the spacer 90 is not limited to a particular orientation. Therefore, the spacer 90 can be suitably used for small children and elderly people.

The spacer 90 is held in the mount portion 12 by fitting the positioning protruding sections 93 into the positioning recessed sections 87 as shown in FIG. 2. In order to detach the spacer 90 from the charging base 10 (or a spacer accommodation portion 96), users can catch the coupling portion 92 with their finger and thumb. Therefore, users can easily detach the spacer 90 from the mount portion 12. Although the exemplary shape of the spacer is described, the spacer can have various shapes. The spacer 90 can be formed of plastic or the like.

### (Spacer Accommodation Portion 96)

The base case 11 has the spacer accommodation portions 96 that are formed to accommodate the spacers 90. The spacer accommodation portions 96 are preferably formed in the bottom surface of the base case 11. Accordingly, the spacer accommodation portions 96 are not externally exposed when the charging base is in use. Therefore, the charging base can have a smooth and simple outward appearance. FIGS. 3 and 4 show the exemplary spacer accommodation portions 96. The exemplary charging base has two mount portions 12. Correspondingly, two spacer accommodation portions 96 are formed to accommodate two spacers 90. In order to accommodate the spacer 90, the exemplary spacer accommodation portion 96 is formed in a recessed shape that has substantially the same size as external shape of the spacer 90. The spacer 90 is fitted into the spacer accommodation portion 96. The spacer 90 can be held in the spacer accommodation portion 96 by elastically deforming the spacer 90. Since base case 11 has the accommodation portions for accommodating the spacers 90, users can store the spacers 90 together with the base case 11. Therefore, it is possible to reduce the possibility of losing the spacers when the spacers are out of use.

In the case where the mount portions 12 are formed on an inclined surface of the base case 11 that has a triangular shape as viewed from the lateral side as shown in FIGS. 3 and 4, the spacer accommodation portions 96 are preferably formed on a side opposite to the mount portion 12 side of the bottom surface of the base case 11. In this case, it is possible to effectively use dead space of the triangular base case 11.

### (Cut-Out Portion 85)

The charging base 10 has the cut-out portions 85 each of which is formed in a surface of the mount portion 12 intersecting a mount surface of the mobile device 50 by cutting out a part of the base case 11 so that the cut-off portion 85 communicates with the outside. Specifically, the surface of the mount portion 12 intersecting the mount surface of the mobile device 50 is the stopper wall 14. Since such the cut-out portion 85 is formed, even if the mobile device 50 includes a member that protrudes from the lower surface of the mobile device 50, when this protruding member is brought in the cut-out portion 85, it is possible to prevent positional deviation between the induction coil 51 and the power supply coil 21 due to upward deviation of the bottom surface of the mobile device 50 from the stopper wall 14. Therefore, it is possible to prevent that the induction coil 51 and the power supply coil 21 are insufficiently electromagnetically coupled to each other. For example, in the case where a strap is attached to the lower surface of the mobile device, when the attachment part of the strap is brought in the cut-out portion 85, the mobile device can be placed to the mount portion with the bottom surface of the mobile device being in contact with the stopper wall 14, without the strap being caught in the gap between the bottom surface of the mobile device and the stopper wall 14. In addition, since the bottom surface of the mobile device is partially externally exposed from the cut-out portion 85, it is possible to dissipate heat from the exposed part of the bottom surface of the mobile device.

### (Second Cut-Out Portion 86)

In addition, the second cut-out portion 86 is formed in the recessed bottom surface of each of the mount portions 12. The second cut-out portion 86 communicates with the cut-out portion 85. Thus, the cut-out part extends from the edge to the back surface of the base case 11. Specifically, the cut-out portion 85 extends in a part of the recessed bottom surface from the edge of the surface intersecting the mount surface so that the edge of the base case 11 opens in a substantially rectangular U shape. Accordingly, even if a mobile device has a protruding part that protrudes from the back surface of the mobile device, such a protruding part can be guided to the second cut-out portion 86. Therefore, it is possible to prevent upward deviation of the back surface of the mobile device from the recessed bottom surface of the mount portion 12, and to appropriately charge the mobile device. In addition, since the externally-exposed area of the mobile device can be increased by the cut-out part that extends from the back surface to the bottom surface of the mobile device, the heat dissipation effect can be improved. Heat is generated by electromagnetic coupling between the induction coil 51 and the power supply coil 21, and the back surface of the mobile device will accumulate the heat. In the case where the cut-out part is formed on the back surface of the charging base so that the cut-out part communicates with the outside, a path can be produced that allows the heat to be externally dissipated. Therefore, it is possible to improve the heat dissipation. As discussed above, although the mount portion 12 required for electromagnetic induction can be arranged in place and in contact with the mobile device, a part of the surface of the mount portion 12 is cut out that is not required for electromagnetic induction. As a result, it is possible to improve the heat dissipation in addition to appropriate electromagnetic induction.

The second cut-out portion 86 communicates with the back surface of the base case. The second cut-out portion 86 penetrates substantially the center of the stopper wall 14 in a length direction of the mount portion 12, and is continuously formed in a rectangular shape extending in a part of the recessed bottom surface as shown in FIG. 1. A second inclined surface 88 is formed at end of the second cut-out portion 86 extending in the recessed bottom surface. The second inclined surface 88 is inclined at an inclination angle greater than the inclination angle of the recessed bottom surface, and substantially smoothly extends from the recessed bottom surface to the lower base case 11B. In the case where the second inclined surface 88 is continuously formed from the recessed bottom surface and inclined at the inclined angle greater than the second inclined surface 88, a protruding member protruding from the mobile device back surface can be smoothly guided to the second cut-out portion 86.

### (Positioning Recessed Section 87)

In addition, the positioning recessed sections 87 can be formed on the opposed inside wall surfaces 89 of the base case 11 that define the second cut-out portion 86 as shown in FIG. 1. The spacer 90 engages with the positioning recessed sections 87. The positioning recessed sections 87 correspond to the positioning protruding sections 93, which protrude from the coupling portion 92 of the spacer 90. The positioning recessed sections 87 are formed in a recessed shape into which the positioning protruding section 93 can be fitted. Accordingly, the spacer 90 can be easily attached in place at a predetermined orientation.

### (Upper Base Case 11A)

The charging base 10 is now described. Charging bases 10 shown in FIGS. 1 to 20 have the mount portion 12 on the upper base case 11A. The mount portion 12 of the upper base case 11A has a U-shaped groove as a curved bottom surface 13. In the mount portion 12 of the illustrated upper base case 11A, the longitudinal direction of the curved bottom surface 13 of U-shaped groove is inclined upward toward the back of the upper base case 11. The stopper wall 14 is arranged on the lower end of the mount portion 12. This mount portion 12 has a U-shaped groove in a cross-sectional view as viewed from the longitudinal direction of the mount portion 12. Accordingly, the mount portion 12 can accurately guide the mobile device 50 to a predetermined position. This upper base case 11A is formed of plastic by molding in a shape that provides a pair of side walls 15 on the both sides of the mount portion 12, and the stopper wall 14 on the lower end of the mount portion 12.

In addition, the upper base case 11A can have a light guide 31 that is externally exposed on the stopper wall 14. The light guide 31 guides light emitted by an LED 30, and emits the light from the light guide 31 outward. The light guide 31 arranged in an exemplary charging base is shown by a diagonally shaded area in the cross-sectional view of FIG. 16. The light guide 31 is formed of transparent plastic. The light guide 31 is secured on the lower base case 11B. The LED 30 is arranged on a circuit board 20 secured in the base case 11. The light guide 31 guides the light from the LED 30 to an exposed portion 31A arranged on the end of the light guide 31, and emits the light from the exposed portion 31A outward. The end of the exposed portion 31A has an exposed part that is externally exposed on the outside of the stopper wall 14, and an exposed part that is externally exposed on the inside (i.e., the mount portion 12 side) of the stopper wall 14. Thus, the light from the LED 30 is emitted from the outside and inside of the stopper wall 14. The light emitted from the inside of the stopper wall 14 illuminates the covering member 40 of the mobile device 50 so that the covering member 40 emits light as shown in FIG. 16.

The charging base 10 includes the power supply coil 21, which is arranged inside the curved bottom surface 13 of the upper base case 11A, as shown in FIGS. 9 to 11. The power supply coil 21 is a flat coil consisting of wire wound in a flat surface. The power supply coil 21 is arranged in proximity to the interior surface of the curved bottom surface 13. The power supply coil 21 is wound in an elongated loop shape that extends in the longitudinal direction of the U-shaped groove so that electric power can be transmitted in an elongated area that extends in the longitudinal direction. Although the illustrated power supply coil 21 is described as a flat coil, the power supply coil can be a planar coil that is curved along the curved surface on the both side of the curved bottom surface.

A shield layer 23 is arranged on a side opposite to the induction coil 51 (the lower side relative to the power supply coil 21 in the Figures) to electromagnetically shield the power supply coil 21. The shield layer 23 is formed of high-permeability metal or ferrite. The shield layer 23 electromagnetically shields the power supply coil 21 on the side opposite to the induction coil 51. The shield layer 23 and the power supply coil 21 are secured to a support base 16 that is formed of plastic and arranged in the base case 11. The circuit board 20 is between the support base 16 and the lower base case 11B. The support base 16 is secured to the lower base case 11B. Thus, the shield layer 23 and the power supply coil 21 are arranged in predetermined positions of the base case 11. This support base 16 has an inclined surface 16A that extends along the curved bottom surface 13. The shield layer 23 and the power supply coil 21 are laminated on and secured to the inclined surface 16A.

The power supply coil 21 is connected to the high-frequency power supply 22 mounted on the circuit board 20 as shown in the circuit diagram of FIG. 17. The high-frequency power supply 22 converts DC electric power provided from an AC/DC adaptor 25 into high-frequency electric power, and provides the converted electric power to the power supply coil 21. The high-frequency power supply 22 includes a circuit that cuts off output of high-frequency electric power when the battery 54 in the mobile device 50 is fully charged. The mobile device 50 includes a charging circuit 52 that detects that the battery 54 of the mobile device 50 is fully charged. The high-frequency power supply 22 communicates with the charging circuit 52 of the mobile device 50. The high-frequency power supply 22 can detect based on the communication with the charging circuit 25 that the battery 54 of the mobile device 50 is fully charged. Thus, the high-frequency power supply 22 cuts off the output when the battery 54 in the mobile device 50 is fully charged.

Since the aforementioned charging base 10 includes two mount portions 12, two mobile devices 50A and 50B can be placed on the mount portions 12 and can be charged. Needless to say, the number of the mount portions is not limited to two, but can be one, or three or more. In the case where a plurality of charging bases can be connected to each other, the number of the mobile devices can be adjusted that are placed on the connected charging bases. For example, the charging bases can be coupled to each other side by side. In this case, each charging base can include a coupler that detachably couples one charging base to another charging base arranged beside the one charging base.

The circuit diagram of the high-frequency power supply 22 in the charging base 10 is shown in FIG. 17. The power supply 22 is provided with electric power from the AC/DC adaptor 25 via a power supply connector 26.

The high-frequency power supply 22 charges the battery 54 of the mobile device 50. That is, the high-frequency power supply 22 energizes the power supply coil 21. An exemplary procedure is now described that charges batteries 54A and 54B of first and second mobile devices 50A and 50B placed on two mount portions by using the circuit shown in FIG. 17. First, DC electric power is provided from the AC/DC adaptor 25 to the power supply 22A of the first mount portion 12A. The power supply 22A of the first mount portion 12A energizes the power supply coil 21A with the DC electric power provided from the AC/DC adaptor 25, and charges the battery MA of the first mobile device 50A. When the battery 54A of the first mobile device 50A is fully charged, the power supply 22A of the first mount portion 12A stops energizing the power supply coil 21A, and the DC electric power is provided to the second mount portion 12B. The power supply 22B of the second mount portion 12B energizes the power supply coil 216 with the provided DC electric power provided, and charges the battery 54B of the second mobile device 50B. When the battery MB of the second mobile device 50B is fully charged, the power supply 22B of the second mount portion 12B stops energizing the power supply coil 21B, and stops charging the battery 54B.

In the case of the circuit in that batteries 54 of a plurality of mobile devices 50 are charged one mobile device after another, the batteries 54 of the mobile devices 50 can be fully charged without increasing output of electric power from the AC/DC adaptor 25.

### (Details of Mobile Device 50)

The mobile device 50 has a curved back surface 53 to be placed on the mount portion 12 of the charging base 10. The curved back surface 53 is formed in a curved shape that extends along the curved bottom surface 13 of U-shaped groove as shown in FIGS. 10 and 11. The induction coil 51 is arranged inside the curved back surface 53. The induction coil 51 is wound in a curved plane extending along the curved back surface 53. FIG. 13 is the perspective view showing the mobile device 50 covered by the detachable covering member 40. The covering member 40 covers a surface part of the mobile device 50 without operation portions 65 such as switches arranged on the case surface of the mobile device 50 so that the operation portions 65 are externally exposed. The illustrated mobile device 50 includes the operation portions 65 such as switches, which are arranged in parts of the front and back surfaces. The covering member covers substantially the whole surface of the back surface of the mobile device 50 without the operation portions 65 except an upper switch portion of the mobile device 50, the outer peripheral surface of the Mobile device 50, and the front outer peripheral part of the mobile device 50. The outer peripheral surface of the mobile device 50 includes the both side surfaces, and upper and lower surfaces. The covering member 40 can elastically contract, and can tightly cover surfaces of the mobile device 50. The covering member 40 can elastically expand, and can be removed from the mobile device 50. The mobile device 50 can be placed on the mount portion 12 of the charging base 10 to charge the battery 54 included in the mobile device 50 with the covering member 40 covering the mobile device 50, or without the covering member. The covering member 40 is formed of elastic soft plastic, or natural or synthetic rubber, and protects the mobile device 50 from shock in accidental drop, collision and the like. When the mobile device 50 with or without the covering member 40 is placed on the mount portion 12 of the charging base 10, as shown in FIGS. 5 to 8, the mobile device 50 is inclined and the top-and-bottom longitudinal direction of the mobile device 50 extends toward the back side of the charging base 10 with an end of the mobile device 50 located on the back side of the charging base being located on the top side of the charging base 50. In this state, the lower end of mobile device 50 is supported by the stopper wall 14.

### (Battery Pack)

The mobile device 50 includes the induction coil 51 inside the curved back surface 53. The induction coil 51 is wound in a curved plane extending along the curved back surface 53. The mobile device 50 shown in FIGS. 10, 11, and 18 has a battery accommodating portion 61. The battery accommodating portion 61 can accommodate a plurality of cylindrical batteries 54 in parallel to each other. A battery pack 70 is detachably mounted to the battery accommodating portion 61. The battery accommodating portion 61 is arranged opening on the back surface of the mobile device 50. After the battery pack 70 is mounted to the battery accommodating portion 61, the opening of the battery accommodating portion 61 is closed. The illustrated mobile device 50 includes the battery 54 and the induction coil 51 in the battery pack 70. The induction coil 51 is accommodated inside the curved back surface 53. The battery accommodating portion 61 has a shape that can accommodate a plurality of AA batteries (two AA batteries in FIGS. 10, 11 and 18) 54B shown by dashed lines in FIGS. 10, 11 and 18. The battery pack 70 has an outward shape that can be detachably mounted to the battery accommodating portion 61 instead of a plurality of AA batteries (two AA batteries in FIGS. 10, 11 and 18) 546. The thus-configured mobile device 50 can be conveniently used both with the AA batteries 54B and the rechargeable battery pack 70 as shown in FIG. 18. Needless to say, it is not always necessary for the mobile device to include the detachable battery pack. The mobile device can include a rechargeable battery that cannot be detached from the mobile device. The mobile device can include the induction coil that is arranged inside the curved back surface and provides charging electric power to this battery. In the case where the AA batteries 54B are mounted to the battery accommodating portion 61, the opening of the mobile device 50 is closed by a detachable lid 63 as shown by the dashed lines in FIG. 18. The detachable lid 63 is detachably attached to the opening of the battery accommodating portion 61. After the detachable lid 63 is removed, the AA batteries 548 can be mounted to the battery accommodating portion 61. After the AA batteries 54B can be mounted, the detachable lid 63 is attached to the mobile device 50 so that the opening of the battery accommodating portion 61 is closed.

The battery pack 70 is mounted to the battery accommodating portion 61 after the detachable lid 63 is removed. The battery pack 70 to be mounted to the battery accommodating portion 61 has a detachable lid configured integrally with the battery pack 70. When this battery pack 70 is mounted to the battery accommodating portion 61, the opening of the battery accommodating portion 61 is closed. The battery pack 70 is shown in FIGS. 19 and 20. FIG. 20 is an exploded perspective view showing the battery pack 70 shown in FIG. 19. FIGS. 10 and 11 are the cross-sectional views of the mobile device 50 placed on the charging base 10. The illustrated battery pack 70 includes a battery case 71, two AAA batteries 54A, a battery holder 72, a circuit board 73, a bracket 74, a shield layer 75, the induction coil 51, and a back surface cover 76. The battery case 71 accommodates the batteries 54. The AAA batteries MA are accommodated in the battery case 71. The battery holder 72 holds the AAA batteries 54A in place. The circuit board 73 is arranged on the battery holder 72, and is connected to the batteries 54. The bracket 74 is arranged on the circuit board 73. The shield layer 75 is arranged on the bracket 74. The induction coil 51 is arranged on the shield layer 75. The back surface cover 76 is arranged on the induction coil 51. The back surface cover 76, the bracket 74, and the battery holder 72 are formed of insulating plastic.

The back surface cover 76 is formed in a curved plane shape that extends along the curved back surface 53 of the mobile device 50. Thus, the exterior and interior surfaces of the back surface cover 76 are curved. The illustrated back surface cover 76 is used instead of the detachable lid 63 for closing the battery accommodating portion 61. For this reason, the back surface cover 76 has an external shape capable of closing the opening of the battery accommodating portion 61, in other words, the same exterior shape as the detachable lid 63. The illustrated battery pack 70 is mounted to the battery accommodating portion 61 of the mobile device 50 by means of the back surface cover 76. Interlocking hooks 77 are formed integrally with the upper end (the lower left side in FIG. 19) of the back surface cover 76. An elastic hook 78 is formed integrally with the lower end (the upper right side in FIG. 19) of the back surface cover 76, and interlocks with the opening of the battery accommodating portion 61. Thus, the back surface cover 76 can be detachably attached to the opening of the battery accommodating portion 61. The retaining recessed portions 67 and 68 are formed on the upper and lower ends of the battery accommodating portion 61 of the battery accommodating portion 61. The interlocking hooks 77 and the elastic hook 78 can interlock with the retaining recessed portions 67 and 68. When users interlock the interlocking hooks 77 with the retaining recessed portions 67 and push the battery pack 70 into the battery accommodating portion 61, the elastic hook 78 can interlock with the retaining recessed portion 68. Thus, the battery pack 70 can be securely mounted in the battery accommodating portion 61. When users elastically deform the elastic hook 78 and detach the elastic hook 78 from the retaining recessed portion 68, the battery pack 70 can be removed from the mobile device 50. Tenon parts 79 are formed in central parts on the both side edges of the back surface cover 76 shown in the cross-sectional views of FIGS. 10 and 11. The tenon parts 79 extend in the longitudinal direction of the back surface cover 76. The tenon parts 79 can be fitted into guiding mortise parts 69 that are formed on the both side edges of the opening both sides of the battery accommodating portion 61 formed in the mobile device 50. Thus, the back surface cover 76 is reliably attached to the opening.

The induction coil 51 is arranged on the interior surface of the back surface cover 76. The induction coil 51 is composed of copper wire as metal the surface of which is provided with an insulating film. The copper wire is wound in a plane. The wounded copper wire is deformed to expand along the curved interior surface of the back surface cover 76. Thus, the induction coil 51 is arranged in proximity to the curved surface of the back surface cover 76. The induction coil 51 has an elongated loop shape that extends in the longitudinal direction of the mobile device 50, in other words, the longitudinal direction of the AAA battery 54A to efficiently electromagnetically couple the induction coil 51 to the power supply coil 21.

The shield layer 75 is laminated on the lower surface of the induction coil 51 to magnetically shield the circuit board 73 and the batteries 54 from the power supply coil 21. The shield layer 75 is formed of high-permeability metal or ferrite, and prevents that high frequency of the power supply coil 21 affects the circuit board 73 and the batteries 54. The shield layer 75 has a curved shape that extends along the induction coil 51, and is arranged in proximity to the back surface of the induction coil 51.

The bracket 74 is formed of plastic. A surface of the bracket 74 facing the back surface cover 76 is formed in a curved shape that extends along the back surface cover 76. A curved gap is arranged between this surface of the bracket 74 and the interior surface of the back surface cover 76. The induction coil 51 and the shield layer 75 are interposed between the surface of the bracket 74 and the interior surface of the back surface cover 76, and is secured in the gap. The back surface of the bracket 74, which faces the circuit board 73, is flat. Alternatively, the back surface of the bracket 74 can have recessed parts that guide electronic components mounted on the circuit board 73 so that the bracket 74 is arranged on the circuit board 73. Positioning protrusions 74a are formed integrally with the surface of the bracket 74, and hold the induction coil 51 in place. The positioning protrusions 74a are guided into the inside hole of the elongated induction coil 51 so that the induction coil 51 is held in place. The positioning protrusions of the bracket 74 shown in FIG. 19 are spaced away from each other in the longitudinal direction of the inside hole of the elongated induction coil 51, and can be arranged at the both ends of the inside hole of the elongated induction coil 51. Accordingly, the positioning protrusions can hold the induction coil 51 in place. In addition, parts of the bracket 74 corresponding to the positioning protrusions 74a are formed thick, and serve as bosses that receive screws for fastening the battery case 71. Fastening screws 81 pass through the battery case 71, and are screwed into the positioning protrusions 74a of the bracket 74. Thus, the battery case 71 is secured to the bracket 74.

Electronic components 84 are mounted on the circuit board 73. The electronic components 84 realize a charging circuit (not shown) that charges the batteries 54 with electric power excited in the induction coil 51. After converting high-frequency electric power excited in the induction coil 51 into direct current, which can charge the batteries 54, the charging circuit charges the batteries 54. The electronic components 84 are mounted on a lower surface in FIG. 20 (an upper surface in FIGS. 10 and 11), in other words, the battery side of the circuit board 73.

The battery holder 72 holds a plurality of AAA batteries (two AAA batteries in the illustrated battery holder) 54B in place, and positions the circuit board 73 in place. The battery holder 72 is formed of plastic, and has holding recessed portions 72a that are arranged on a battery-facing surface to hold the batteries 54. The illustrated battery pack 70 includes two AAA batteries 54A. Correspondingly, two holding recessed portions 72a are arranged in parallel to each other extending along the cylindrical shape of the AAA batteries 54A. The battery pack 70 with the AAA batteries 54A can be mounted to the battery accommodating portion 61 instead of the AA batteries 54B shown by the dashed lines in FIGS. 10 and 11. The AAA battery 54A has an outer diameter smaller than the AA battery 54B. Accordingly, as shown in FIGS. 10 and 11, the distance between the center lines of the AAA batteries 54A is designed larger the AA batteries 54B mounted to the battery accommodating portion 61. Thus, the gap between the center lines of the AAA batteries 54A can be wide. An accommodation space portion 82 is formed in this gap. The electronic components 84 mounted on the circuit board 73 are arranged in the accommodation space portion 82. That is, the AAA batteries 54A are arranged outside as far as possible so that the accommodation space portion 82 between the batteries is increased.

Peripheral walls 72b are formed integrally with the battery holder 72 on a board-facing surface of the battery holder 72 that faces the circuit board 73. The circuit board 73 can be arranged inside the peripheral walls 72b, and held in place. The circuit board 73 is fitted into space inside the peripheral walls 72b, and held in place. In addition, the battery holder 72 has a recessed portion 72c on the board-facing surface. The recessed portion 72c can guide electronic components 84 mounted on the circuit board 73. Since the recessed portion 72c is located between the adjacent batteries 54, it is possible to effectively use the accommodation space portion 82 formed between the batteries 54 to accommodate the electronic components 84.

The battery case 71 is formed of plastic in a box shape that can accommodate a plurality of AAA batteries (two AAA batteries in the illustrated battery case 71) 54A. The battery case 71 has an opening facing the back surface cover 76. The opening rims of the box-shaped battery case 71 are coupled to the back surface cover 76 by a fit-in retaining structure or by welding. Thus, the opening of battery case 71 is closed by the back surface cover 76 so that the battery pack is assembled. A guiding groove 71a is formed on the bottom surface of the battery case 71 shown in the cross-sectional view of FIGS. 10 and 11. The guiding groove 71a guides a partitioning wall 66 arranged in the battery accommodating portion 61. The partitioning wall 66 is arranged between the batteries 54 to accommodate the M batteries 54B in place. Holding ribs 71b are formed integrally with the battery case 71 on the both sides of the guiding groove 71a. The holding ribs 71b can hold the AAA batteries 54A in place. The AAA batteries 54A are held in place by interposing each of the AAA batteries 54A between each of the holding ribs 71b and each of the side walls of the battery case 71. In addition, the battery case 71 has terminal windows 71c that opens to externally expose output terminals 83. Thus, the output terminals 83 are externally exposed from the terminal windows 71c. The output terminals 83 of the battery pack 70 can be in contact with power supply terminals 62 arranged in the battery accommodating portion 61 so that electric power is provided to the mobile device 50. The power supply terminals 62 are arranged at the same positions as terminals of the AA batteries 54B when the AA batteries 54B are accommodated in the battery accommodating portion 61. Thus, the battery pack 70 can be accommodated instead of the AA batteries 54B so that electric power is provided to the mobile device 50 from the battery pack 70.

The aforementioned battery pack 70 is assembled by the following processes.

(1) The batteries 54 are accommodated in the battery case 71, and then the battery holder 72 is placed on the batteries 54 so that the batteries 54 are held in place.
(2) The circuit board 73 and the bracket 74 are placed on the battery holder 72. Subsequently, the shield layer 75 is placed on the bracket 74, and then the induction coil 51 is placed to interpose the shield layer 75 between the bracket 74 and the induction coil 51. The induction coil 51 is arranged in a predetermined position of the bracket 74. After that, the circuit board 73, the battery 54, and the induction coil 51 are connected to each other. The output terminals 83 connected to the circuit board 73 is arranged in the terminal windows 71c of the battery case 71 on the interior side.
(3) The fastening screws 81 are brought to pass through the battery case 71, and are screwed into the positioning protrusions 74a of the bracket 74. Thus, the battery case 74 is secured to the bracket 71 so that a battery assembly 80 is configured.
(4) The opening rims of the battery case 71 are coupled to the back surface cover 76 so that the battery assembly 80 is secured to the back surface cover 76.

In the thus-configured mobile device and charging base system according to this embodiment, the mobile device 50 can be covered by the detachable covering member 40, and the mount portion 12 of the charging base 10 has an inner shape that can receive the mobile device 50 covered by the covering member 40. According to the thus-configured mobile device and charging base system, in either case where the mobile device 50 is covered or not covered by the covering member 40, the mobile device 50 can be guided to the predetermined position of the mount portion 12 so that the power supply coil 21 is arranged in proximity to the induction coil 51. Therefore, it is possible to efficiently charge the batteries 54 of the mobile device 50.

As shown in FIG. 10, when the mobile device 50 without the covering member is appropriately placed, the lowest part of the curved bottom surface 13 of the charging base 10 aligns with and comes in contact with the lowest part of the curved back surface 53 of the mobile device 50. Since the curved bottom surface 13 of the charging base 10 and the curved back surface 53 of the mobile device 50 have symmetrical shapes, when the mobile device 50 is mounted to the mount portion 12 of the charging base 10, the mobile device 50 slides down by its weight and can be placed at the appropriated position. In the case where the curved bottom surface 13 of the charging base 10 and the curved back surface 53 of the mobile device 50 are formed of a plastic material with small friction coefficient, the mobile device 50 can slide down and can be thus placed at the appropriated position.

Also, in the case where the mobile device 50 is covered by covering member 40 as shown in FIG. 11, it possible to easily put the mobile device 50 in place and to efficiently charge the mobile device 50. The reason is that, when the curved back surface 53 of the mobile device 50 is placed onto the curved bottom surface 13 of the charging base 10, the mobile device 50 can be put in place as follows:

(1) When the lowest part of the curved bottom surface 13 of the charging base 10 aligns with the lowest part of the curved back surface 53 of the mobile device 50, the mobile device 50 can be suitably put in place.
(2) Since the curved bottom surface 13 of the charging base 10 and the curved back surface 53 of the mobile device 50 have symmetrical shapes, when the center lines the charging base 10 and the mobile device 50 align with each other, the mobile device 50 can be suitably put in place.
(3) If the front surface of the mobile device 50 is horizontally arranged in the right-and-left direction, the mobile device 50 can be suitably put in place.

### INDUSTRIAL APPLICABILITY

A charging base for the mobile device, and a charging base and mobile device system according to the present invention can be suitably used to charge game controller, cordless telephone, mobile phone, portable music player, and the like.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2009-237,766 filed in Japan on Oct. 14, 2009, the content of which is incorporated herein by reference.

What is claimed is:

1. A charging base capable of charging a mobile device including an induction coil and a battery pack that includes a battery to be charged by electric power induced in this induction coil, the charging base comprising:
a base case;
a mount portion that is formed in a recessed shape in section on the surface of said base case, and can detachably hold the mobile device at a predetermined position;
a power supply coil that is arranged in proximity to and inside the recessed bottom surface of said mount portion, and can be electromagnetically coupled to the induction coil for the battery pack attached to said mobile device; and
a power supply that is connected to said power supply coil,
wherein a cut-out portion is formed in a surface of said mount portion intersecting a mount surface of the mobile device extending along the recessed bottom surface by cutting out a part of said base case so that the cut-off portion communicates with the outside.

2. The mobile device charging base according to claim 1, wherein a second cut-out portion is additionally formed in the recessed bottom surface of said mount portion, wherein said second cut-out portion communicates with said cut-out portion, and extends in a part of the recessed bottom surface from the edge of the surface intersecting said mount surface so that the edge of said base case opens in a substantially rectangular U shape.

3. The mobile device charging base according to claim 1 further comprising a spacer that can be attached to a stopper wall so that an actual size of said mount portion can be changed, wherein the stopper wall can support the lower surface of the mobile device.

4. The mobile device charging base according to claim 3, wherein said spacer includes two block portions, and a coupling portion that couples the two block portions to each other, wherein said block portions are designed to have surfaces substantially coplanar with interior wall surfaces of the base case when said spacer is attached to said mount portion, and wherein the interior wall surfaces of the base case face each other and define said cut-out portion.

5. The mobile device charging base according to claim 4, wherein said spacer has a positioning protruding section that protrudes toward a side to be inserted into said mount portion, wherein a positioning recessed section is formed at a position of said mount portion corresponding to said positioning protruding section so that, when the positioning protruding section of said spacer is inserted into the positioning recessed section of said mount portion, said spacer is positioned in place.

6. The mobile device charging base according to claim 5, wherein said base case has a spacer accommodation portion that accommodates said spacer.

7. The mobile device charging base according to claim 6, wherein said mount portion is formed inclined on said base case.

8. The mobile device charging base according to claim 7, wherein said spacer accommodation portion is located on the underside of said base case that is a side opposite to the side where said mount portion is formed.

9. The mobile device charging base according to claim 1, wherein said mount portion has a substantially U shape in section.

10. A mobile device and charging base system comprising:
a mobile device having:
a device case,
a rechargeable battery that is detachably attached to said device case, and
an induction coil that charges said rechargeable battery by induced electric power; and
a charging base having:
a base case,
a mount portion that is formed in a recessed shape in section on the surface of said base case, and can detachably hold said mobile device at a predetermined position,
a power supply coil that is arranged in proximity to and inside a recessed bottom surface of said mount portion, and can be electromagnetically coupled to the induction coil of the mobile device pack placed on said mount portion, and
a power supply that is connected to said power supply coil,
wherein said charging base has a cut-out portion that is formed in a surface of said mount portion intersecting a mount surface of said mobile device extending along the recessed bottom surface by cutting out a part of said base case so that the cut-off portion communicates with the outside.

11. The mobile device and charging base system according to claim 10, wherein an option unit can be coupled to said device case of said mobile device, wherein said mount portion of said charging base is designed so that said power supply coil is electromagnetically coupled to said induction coil when said mobile device with the option unit coupled thereto is placed on said mount portion, and wherein said mount portion of said charging base can receive a spacer that adjusts the position of said mobile device so that said power supply coil is electromagnetically coupled to said induction coil even when said mobile device without the option unit is placed on said mount portion.
